(19) United States
(12) Patent Application Publication
(10) Pub. No.: US 2014/0067835 A1
(43) Pub. Date: Mar. 6, 2014

(54) SEARCH EXTENSIBILITY APPLICATION FRAMEWORK IN A HOSTED SEARCH

(71) Applicants: Joshua Harrison, Kirkland, WA (US); Amit Kumar, Redmond, WA (US); Jason Lee, Carnation, WA (US)

(72) Inventors: Joshua Harrison, Kirkland, WA (US); Amit Kumar, Redmond, WA (US); Jason Lee, Carnation, WA (US)

(73) Assignee: MICROSOFT CORPORATION, Redmond, WA (US)

(21) Appl. No.: 13/598,897

(22) Filed: Aug. 30, 2012

(51) Int. Cl. G06F 17/30

(52) U.S. Cl. 707/755; 707/E17.014

(57) ABSTRACT

A search extensibility application framework enables a hosted web search experience to be extended so that apps which are related to a search query can be presented to a user of a client computing device such as a smartphone. In various illustrative examples, a hosted search app is implemented using HTML5 code generated at a remote search provider server. Responsively to a user query at the search app's user interface (“UI”), the server returns an HTML5 payload including meta tags specifying criteria including app extension categories, actions, and known apps that support search terms in the query. Apps that are installed on the client device which match the criteria can then be displayed and launched through the UI to advantageously enable the users to complete a task specific search. JavaScript interfaces are provided to enable apps to update their install state and to be injected into the hosted search app.

### BACKGROUND

The fifth revision of the HyperText Markup Language, named “HTML5,” is formally defined by an international standards body known as the World Wide Web Consortium (“W3C”). HTML5 includes more than 100 specifications that relate to the next generation of Web technologies. HTML5 describes a set of HTML, CSS (Cascading Style Sheets), and JavaScript specifications configured to enable designers and developers to build the next generation of web sites and applications (“apps”). While such technologies perform satisfactorily in many usage scenarios, opportunities still exist for enhanced and richer web application experiences to be implemented.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A search extensibility application framework enables a hosted web search experience to be extended so that apps which are related to a search query can be presented to a user of a client computing device such as a smartphone. In various illustrative examples, a hosted search app is implemented using HTML5 code generated at a remote search provider server. Responsively to a user query at the search app's user interface (“UI”), the server returns an HTML5 payload including meta tags specifying criteria including app extension categories, actions, and known apps that support search terms in the query. Apps that are installed on the client device which match the criteria can then be displayed and launched through the UI to advantageously enable the users to complete a task specific search. For example if a user is searching for a movie, apps can be presented and launched from within the search context to enable the user to locate a nearby movie theatre and then purchase tickets.

A JavaScript interface is provided that further enables apps that are installed on the client device which match the app extension categories or actions, but which are unknown to the search provider, to be injected into the hosted search app. Parameters may be provided to the server from the client computing device in the form of JSON (JavaScript Object Notation) blobs, which contain rich information including the installed version, supported operating system (“OS”), app icon path, app title, and localized caption to display in the UI. The interface may also be utilized to enable side-loaded apps to access the hosted search app UI for development, testing, and debugging. Another JavaScript interface enables installed apps to update their current install state to ensure that the UI renders appropriately at the device and the launched apps perform according to user expectations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing environment in which the present search extensibility application framework may be implemented;

FIG. 2 shows an illustrative layered architecture that supports a hosted search app;

FIG. 3 is an illustrative flowchart that shows the interaction between the hosted search app and a search extensibility service that is exposed by a search provider;

FIG. 4 graphically depicts illustrative JavaScript interfaces exposed by a mobile search engine that enables updates and apps to be injected into the hosted search app, as well as providing for side-loading of third party apps for development, testing, and debugging purposes;

FIG. 5 shows an illustrative set of parameters that may be passed to a JavaScript function to update an installed app to the hosted search app;

FIG. 6 shows an illustrative set of parameters that may be passed to a JavaScript function to explicitly identify installed apps that are unknown, or to enable a third party developed app to be tested and debugged when interoperating with the hosted search app;

FIGS. 7-10 show various screen shots of a user interface displayed by a device that illustrate aspects of the present search app extensibility; and

FIG. 11 is a simplified block diagram of an illustrative computer system such as a personal computer, computing device, or server with which the present search extensibility application framework may be implemented.

Like reference numerals describe like elements in the drawings.

### DETAILED DESCRIPTION

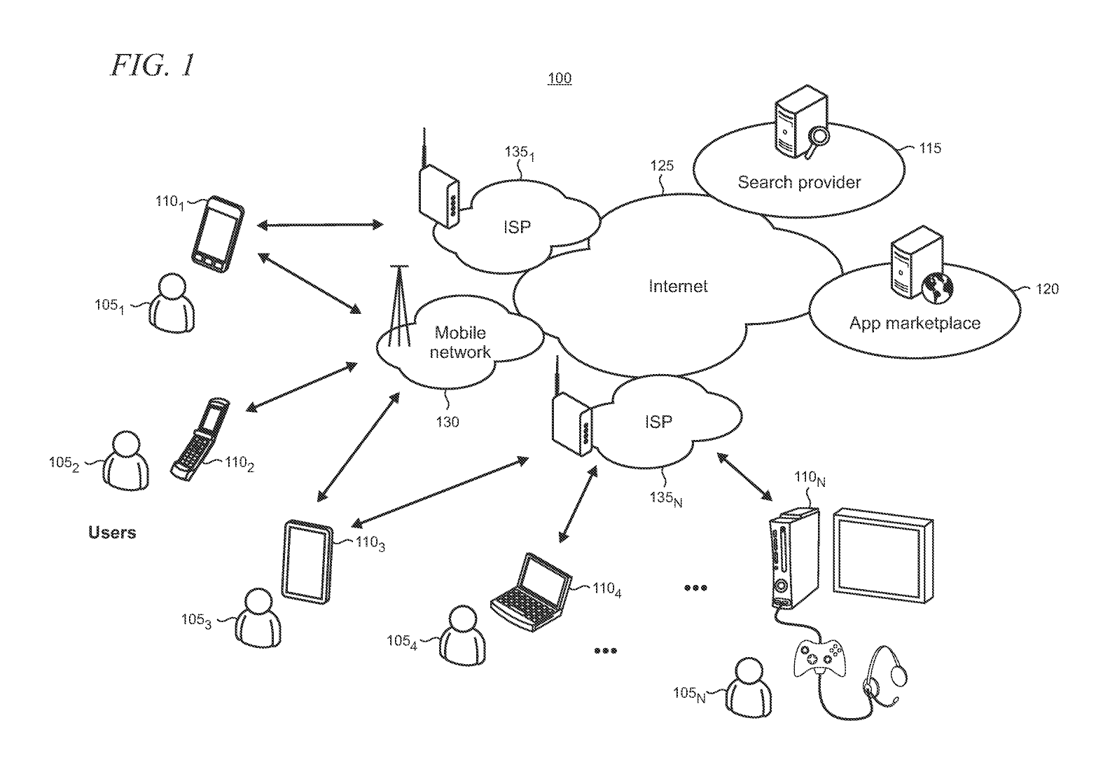

FIG. 1 shows an illustrative computing environment 100 in which the present search extensibility application framework may be implemented. In the environment 100, a number of web application users 105 employ respective computing devices 110 to access web-based resources including a search provider 115 and app marketplace 120 over the Internet 125. The computing devices 110 can comprise a variety of platforms having various features and functionalities (where not all of such platforms are illustrated in FIG. 1) including, for example, mobile phones, smart phones, personal computers (“PCs”), ultra-mobile PCs, PDAs (personal digital assistants), e-mail appliances, digital media players, tablet computers, handheld gaming platforms and gaming consoles, notebook and laptop computers, Internet-connected televisions, set-top boxes, GPS (Global Positioning System) and navigation devices, digital cameras, and devices having various combinations of functionalities provided therein. It is emphasized, however, that the preceding list is intended to be illustrative, and that the present arrangement can be expected to be utilized on any of a variety of platforms that support HTML5 functionalities or a subset thereof.

Typically, the computing devices 110 will have some form of network connectivity feature, either directly or through an intermediary device (e.g., an Internet-connected personal computer) and support user interactivity through a display and input device such as a touchscreen, keypad, pointing device, and the like. As shown in FIG. 1, the computing devices 110 may access the Internet 125 and the search provider 115 using a mobile network 130, or through Internet Service Providers (“ISPs”) 135, or using both in some cases. The devices 110 may come pre-loaded with various apps, and the users 105 may also install apps from local storage media, or via download from the app marketplace 120 either directly, and/or using an intermediary device.

In typical implementations, a smartphone and/or tablet device having a rechargeable battery with multimedia rendering and data communication capabilities (and voice communications in some instances), can often be expected to be utilized as users frequently pick such devices for their convenience and full suite of functionalities and supported user experiences.

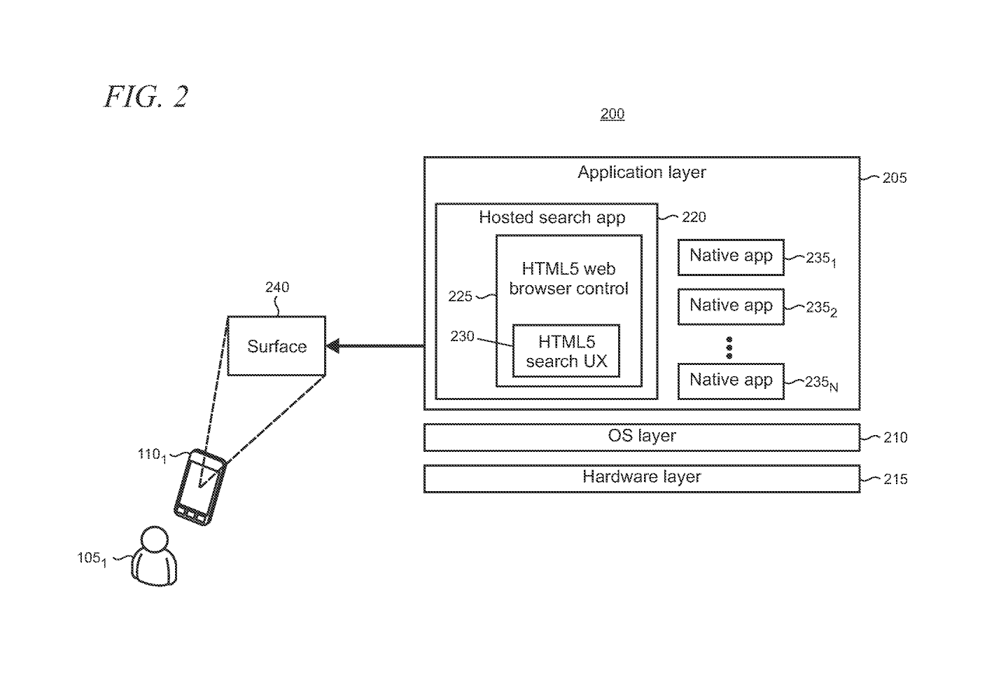

FIG. 2 shows an illustrative architecture 200 of functional components that may be instantiated on a given computing device 110 such as a smartphone. The architecture 200 is typically implemented in software, although combinations of software, firmware, and/or hardware may also be utilized in some cases. The architecture 200 is arranged in layers and includes an application layer 205, an OS layer 210, and a hardware layer 215. The hardware layer 215 provides an abstraction of the various hardware used by the device 110 (e.g., input and output devices, networking hardware, etc.) to the layers above it.

The application layer 205, in this example, supports a hosted search app 220 that provides a search functionality to the user 105 through a web browser control 225 that supports a user experience (“UX”) 230 using HTML5 code. As shown, the application layer 205 also supports a variety of native applications 235_{1, 2 . . . N} that are generally implemented using locally executing code for the most part. In some cases, however, the native apps 235 may also rely on services and/or remote code execution provided by remote servers. A surface component 240, in typical implementations, is exposed by the OS layer 210 and/or hardware layer 215 so that the apps (both hosted and native) can draw a user interface (“UI”) including various user controls that may be rendered on the display screen of the computing device 110. With some devices, the display operates as a touchscreen.

The search app is considered “hosted” because it operates under a hosted application model in which the bulk of the business logic that supports the app is implemented using code that executes on a server remotely from the client computing device. In this particular example, the hosted search app 220 provides the local UX at the device 110 using code that is remotely generated by the search provider 115 (FIG. 1). The UX provided under the hosted application model at the computing device 110 will typically be transparent to the user. That is, the hosted search app 220 will appear and function in most usage scenarios as if it were locally executing like a native app.

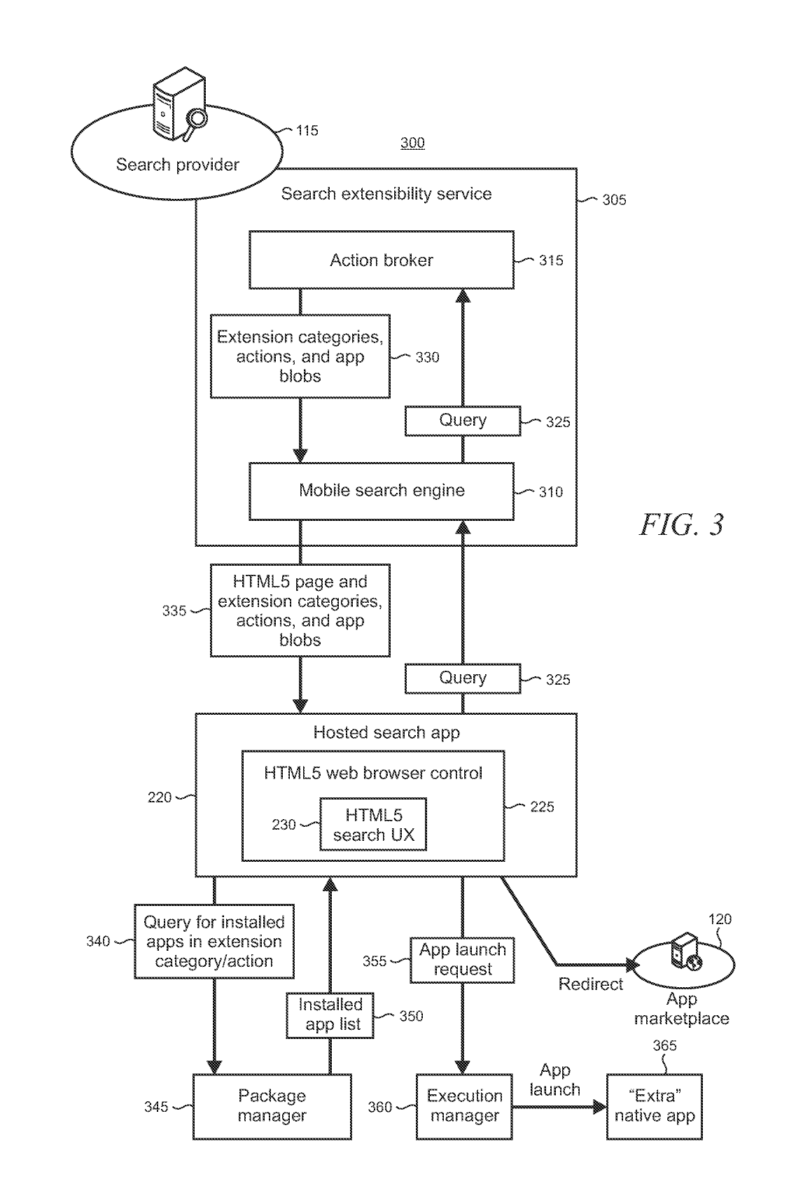

FIG. 3 is an illustrative flowchart 300 that shows the interaction between the hosted search app 220 and a search extensibility service 305 that is exposed by the search provider 115. The search extensibility service 305 uses several components including a mobile search engine 310 and an action broker 315. When a user enters a search term or phrase into the UI of the hosted search app 220, a corresponding query 325 is sent via a network connection to the mobile search engine 310. The mobile search engine relays the query 325 to the action broker 315.

The action broker 315 parses the received query 325 to identify one or more of native apps that support the user's search and also provides other relevant data. Such supported native apps are termed “extras” in this example. To make the identification, developers of native apps will register their apps in advance with the search extensibility service 305 using one or more app extension categories. Various app extension categories can be used depending on the requirements of a particular implementation. For example, app extension categories may fall into one of three types include movies, places, and products. Thus, using the product type as one example, the app extension categories may include arts and crafts, baby and nursery, electronics, computing, flowers, and the like. The extension categories may use a naming convention such as “Bing_Products_Baby_and_Nursery”.

Upon parsing the query 325, the action broker 315 sends a data package 330, for example in the form of HTML meta tags, to the mobile search engine 310. The data package 330 includes the app extension categories that are supported for the query 325, a list of actions (described below) supported for the query, and a list of known apps that support the query. The data in the package will typically be specified by the action broker by matching the data against some pre-determined criteria to identify the intent of the user when formulating the terms in a given search. In addition, for the apps, blobs such as JSON blobs, can be used to provide rich app information including, for example, version, supported OS, a path to an app icon, app title, and a localized caption to display in the UI.

Actions may also be associated with native apps. In this case, an action name may be appended to an app extension category to create another set of extensions termed “app extension actions”. For example, if an app is registered with the app extension category “Bing_Movie” and that app supports the purchase of movie tickets, then the app may also register with the app extension action “Bing_Movie.Buy”. App extension categories and app extension actions are handled in a similar way as far as client-side business logic and can be expected to provide a broad and rich set of extensions or be utilized to further disambiguate information presented to the user through the device UI.

The mobile search engine 310 uses the data 330 received from the action broker 315 to build HTML5 payload 335 which includes documents for rendering on the surface and a data package including the identified action app extensions (i.e., categories and/or actions), lists of apps and actions, and the associated app blobs. In the documents, the head section can provide the following extension category and/or extension action meta tags to indicate the page needs support for extras. This will trigger the lookup of installed extras as described below.

<head>

<meta name=”bing-extensioncategoryid”

content=”<extension category value>”>
</head>
For example:
<head>

<meta name=”bing-extensioncategoryid”

content=”Bing_Movies”>

<meta name=”bing-extensioncategoryid”

content=”Bing_Movies.Buy”>
</head>

The HTML5 payload including the documents and data package are sent to the hosted search app 220 over the network. The hosted search app 220 responsively generates an app query 340 to a package manager 345. The query 340 functions as a request for a list of native apps 235 (FIG. 2) that are already installed on the device 110 and match the criteria specified in the payload 335.

The package manager 345, which has knowledge of the installed native apps on the device 110 and their states, will look up apps that match the specified criteria and provide an installed app list 350 to the hosted search app 220. In response to the list, an app launch request 355 is generated and sent to an execution manager 360 which responsively launches the appropriate native app as an extra, as indicated by reference numeral 365. In the event that a matching app is not already installed on the device 110, then the hosted search app 220 may redirect the user 105 to the app marketplace 120, as shown. Users may download a matching app from the app marketplace at their option.

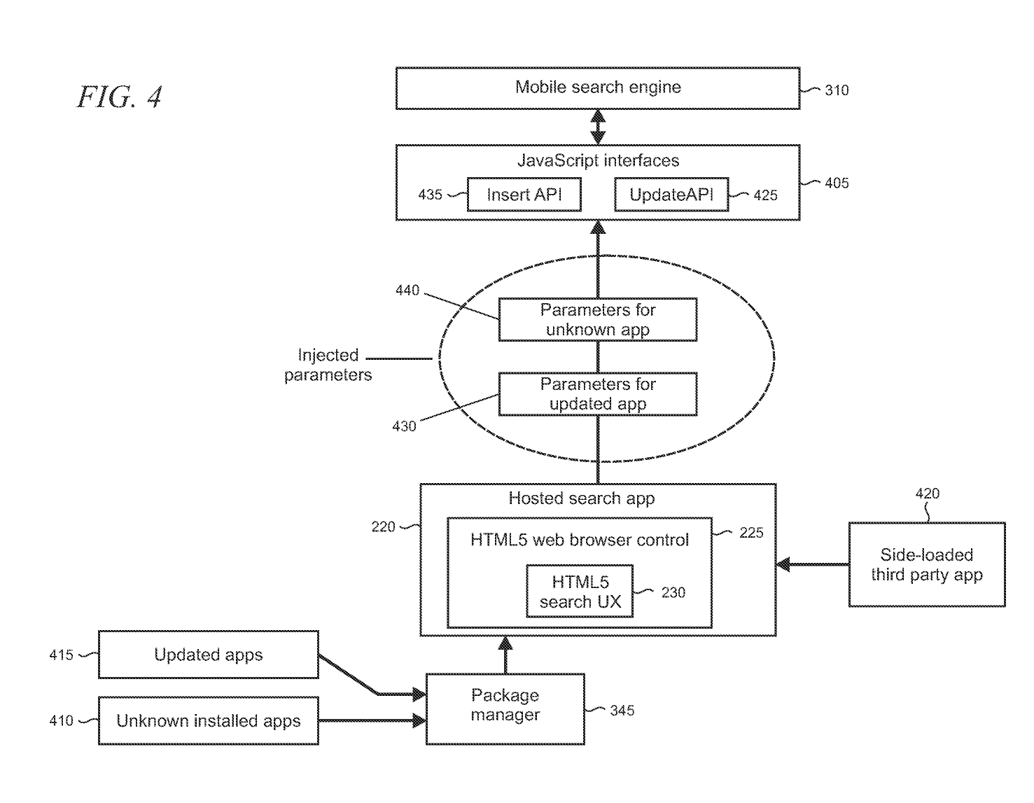

FIG. 4 graphically depicts illustrative JavaScript interfaces 405 that are exposed by the mobile search engine 310. The JavaScript interfaces 405 may be called to inject parameters associated with unknown installed apps 410 and app updates 415 into the hosted search app 220. The JavaScript interfaces 405 may also be utilized for side-loading of a third party app 420 into the hosted search app UI for development, testing, and debugging purposes. A side-loaded app is typically one that is not obtained from a known or trusted source such as the app marketplace 120 (FIG. 1).

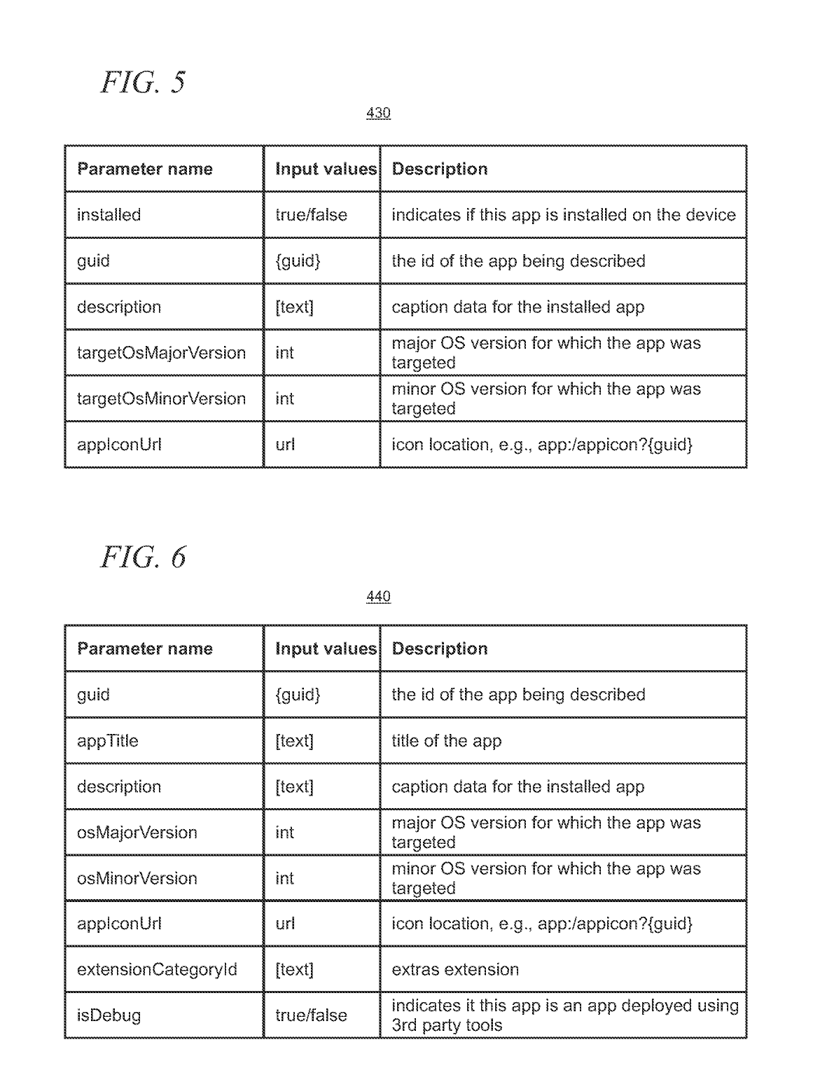

In the update case, an update API 425 (application programming interface) may be called for each occurrence of <<a href=“app://{ . . . }”> in a document in the payload 335 (FIG. 3). This enables the HTML5 documents to be rendered properly on the surface based on the current install state of a given native app. For each occurrence, the package manager 345 is queried to determine if the referenced app is installed and to obtain parameters 430 to pass to the update API 425. The parameters 430 are shown in detail in FIG. 5.

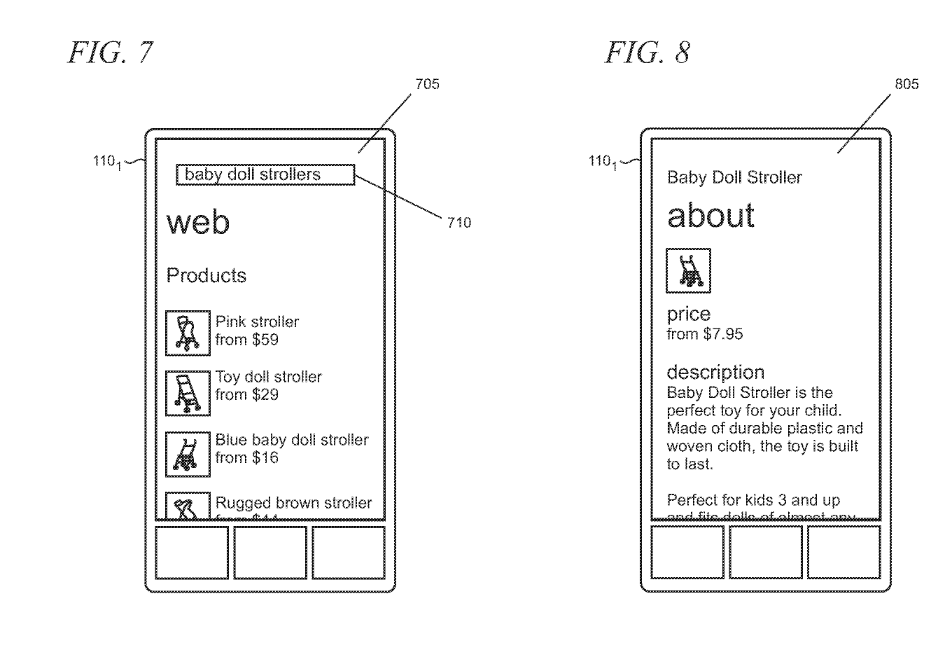

In the unknown app case, an insert API 435 may be called to enable extras apps to be injected into the hosted search app 220 for apps that are already installed on the device 110, but which have not been explicitly identified by the mobile search engine 310. The insert API 435 is triggered upon the occurrence of an extension category or extension action meta tag in the HTML5 document. For each occurrence, the package manager 345 is queried to obtain parameters 440 to pass to the insert API. The parameters 440 are shown in detail in FIG. 6. As shown in FIG. 6, an “is Debug” parameter is included. This parameter enables side-loaded apps developed by third parties to inform the hosted search app that they are side-loaded. These side-loaded apps can then be injected into the hosted search app 220 for development, testing, and debugging purposes.

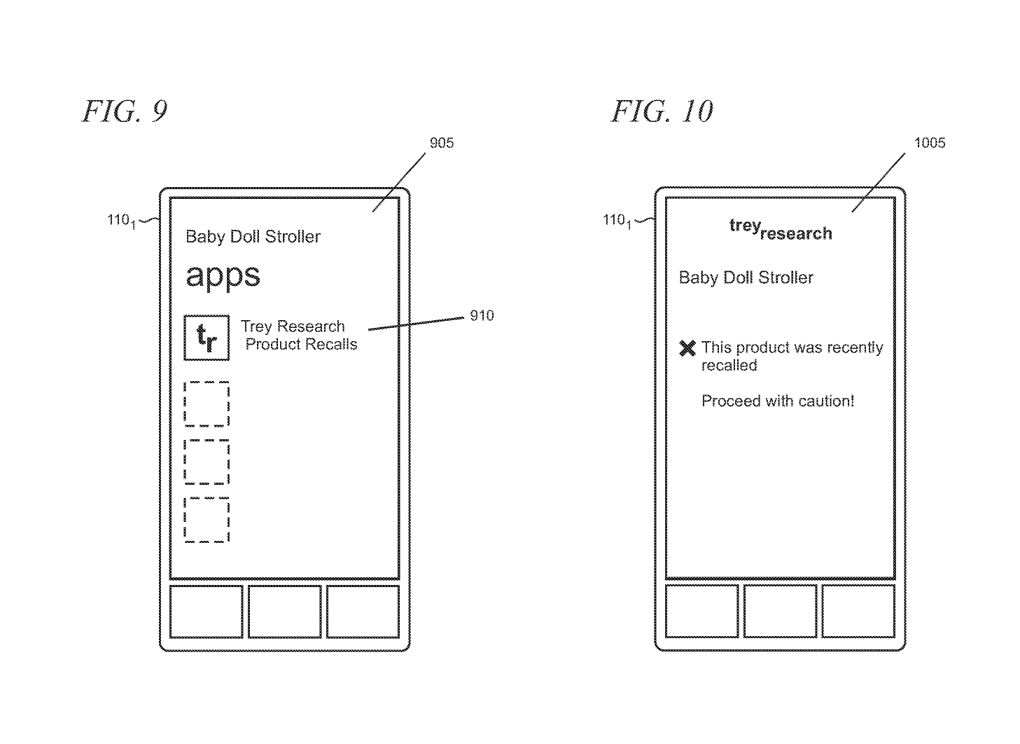

FIGS. 7-10 show various simplified screen shots of a UI displayed by a device 110 which illustrate the present search app extensibility. The UI shows search results which are displayed using detailed quick cards which include a number of pivot pages. As described above, the UI is generated using HTML5 code that is generated by the mobile search engine 310 (FIG. 3).

In the example shown in FIGS. 7-10, a product search is shown, although the UI would be similar for searches dealing with other categories and topics. FIG. 7 shows a screen shot which displays results based on a user's query 710 in a “web” pivot page 705. When the user selects a displayed product, a Products quick card is launched for that particular product. The quick card in this example includes an “about” pivot page 805, as shown in FIG. 8, which provides more detail about the selected product.

The quick card further includes an “app” pivot page 905 as shown in FIG. 9. The app pivot page is populated with native apps that extend the search experience for the user 105. The app pivot page 905 includes apps that are registered with the product type extension category and which the action broker 315 (FIG. 3) has determined are relevant to the user's query. In this particular example, a single app 910 is shown in the app pivot page 905, although other apps might be displayed in a columnar manner in other usage examples, as indicated by the dashed rectangles.

In some cases, the app pivot page can show both installed apps and uninstalled apps that would need to be obtained, for example, from the app marketplace. The installed apps can be listed at the top of the pivot page, for example ahead of the uninstalled apps, or the uninstalled apps might be grayed out to indicate that they are not immediately available to the user to be launched. FIG. 10 shows a UI 1005 of the app 910 when launched.

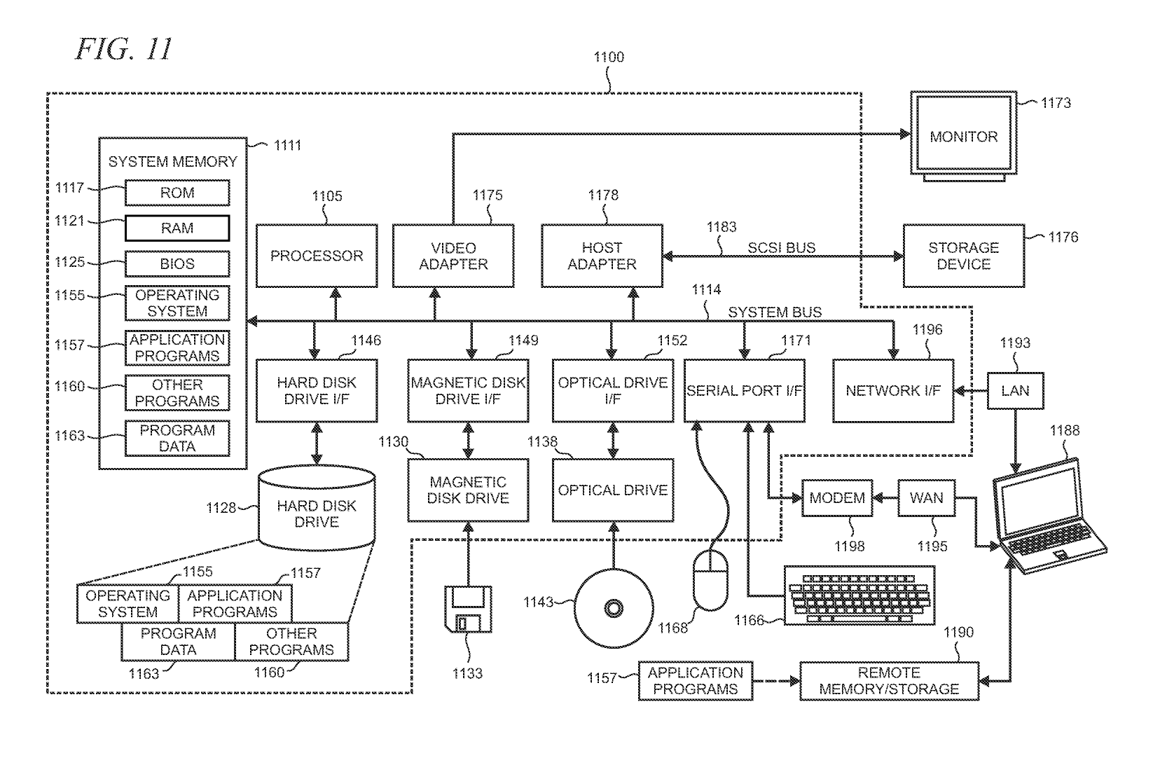

FIG. 11 is a simplified block diagram of an illustrative computer system 1100 such as a PC, client computing device, web server, or other server with which the present search app extensibility may be implemented. Computer system 1100 includes a processor 1105, a system memory 1111, and a system bus 1114 that couples various system components including the system memory 1111 to the processor 1105. The system bus 1114 may be any of several types of bus structures including a memory bus or memory controller, a peripheral bus, or a local bus using any of a variety of bus architectures.

The system memory 1111 includes read only memory (“ROM”) 1117 and random access memory (“RAM”) 1121. A basic input/output system (“BIOS”) 1125, containing the basic routines that help to transfer information between elements within the computer system 1100, such as during start up, is stored in ROM 1117. The computer system 1100 may further include a hard disk drive 1128 for reading from and writing to an internally disposed hard disk (not shown), a magnetic disk drive 1130 for reading from or writing to a removable magnetic disk 1133 (e.g., a floppy disk), and an optical disk drive 1138 for reading from or writing to a removable optical disc 1143 such as a CD (compact disc), DVD (digital versatile disc), or other optical media. The hard disk drive 1128, magnetic disk drive 1130, and optical disk drive 1138 are connected to the system bus 1114 by a hard disk drive interface 1146, a magnetic disk drive interface 1149, and an optical drive interface 1152, respectively.

The drives and their associated computer-readable storage media provide non-volatile storage of computer readable instructions, data structures, program modules, and other data for the computer system 1100. Although this illustrative example shows a hard disk, a removable magnetic disk 1133, and a removable optical disk 1143, other types of computer-readable storage media which can store data that is accessible by a computer such as magnetic cassettes, flash memory cards, digital video disks, data cartridges, RAMs, ROMs, and the like may also be used in some applications of the present search app extensibility. In addition, as used herein, the term computer readable medium includes one or more instances of a media type (e.g., one or more magnetic disks, one or more CDs, etc.).

A number of program modules may be stored on the hard disk, magnetic disk 1133, optical disk 1143, ROM 1117, or RAM 1121, including an operating system 1155, one or more application programs 1157, other program modules 1160, and program data 1163. A user may enter commands and information into the computer system 1100 through input devices such as a keyboard 1166 and pointing device 1168 such as a mouse, or via voice using a natural user interface (“NUI”)(not shown in FIG. 11).

Other input devices (not shown) may include a microphone, joystick, game pad, satellite disk, scanner, or the like. These and other input devices are often connected to the processor 1105 through a serial port interface 1171 that is coupled to the system bus 1114, but may be connected by other interfaces, such as a parallel port, game port, or universal serial bus (“USB”). A monitor 1173 or other type of display device is also connected to the system bus 1114 via an interface, such as a video adapter 1175.

In addition to the monitor 1173, devices typically include other peripheral output devices (not shown), such as speakers and printers. The illustrative example shown in FIG. 11 also includes a host adapter 1178, a Small Computer System Interface (“SCSI”) bus 1183, and an external storage device 1176 connected to the SCSI bus 1183.

The computer system 1100 is operable in a networked environment using logical connections to one or more remote computers, such as a remote computer 1188. The remote computer 1188 may be selected as another personal computer, a server, a router, a network PC, a peer device, or other common network node, and typically includes many or all of the elements described above relative to the computer system 1100, although only a single representative remote memory/storage device 1190 is shown in FIG. 11.

The logical connections depicted in FIG. 11 include a local area network (“LAN”) 1193 and a wide area network (“WAN”) 1195. Such networking environments are often deployed, for example, in offices, enterprise-wide computer networks, intranets and the Internet.

When used in a LAN networking environment, the computer system 1100 is connected to the local area network 1193 through a network interface or adapter 1196. When used in a WAN networking environment, the computer system 1100 typically includes a broadband modem 1198, network gateway, or other means for establishing communications over the wide area network 1195, such as the Internet. The broadband modem 1198, which may be internal or external, is connected to the system bus 1114 via the serial port interface 1171.

In a networked environment, program modules related to the computer system 1100, or portions thereof, may be stored in the remote memory storage device 1190. It is noted that the network connections shown in FIG. 11 are illustrative and other means of establishing a communications link between the computers may be used depending on the specific requirements of a particular application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for implementing a search extensibility application (app) framework using a server operated by a search provider, the method comprising the steps of:
receiving a search query from a hosted search app operating on a computing device;
parsing the received query to identify one or more search terms;
generating a HTML5 payload including documents and meta tags which specify data supported by the one or more search terms, the specifying being performed according to pre-determined matching criteria, the data including one of app extension categories, app extension action, and a list of apps that are known to the server;
providing the HTML5 payload to the hosted search app, the HTML5 payload being renderable by the hosted search app to implement a user interface (UI);
exposing a first API (application programming interface) to the hosted search app, the first API being callable by the hosted search app to update an install state of each of one or more installed apps on the computing device; and
exposing a second API to the hosted search app, the second API being callable by the hosted search app to inject apps into the hosted search app, the injected apps being installed on the client computing device but which are unknown to the server.

2. The method of claim 1 in which the hosted search app includes a user interface that is substantially implemented using HTML5 code.

3. The method of claim 2 in which the HTML5 code executes within a web browser control.

4. The method of claim 1 in which the app extension categories are typed, the types including product, places, and movies.

5. The method of claim 1 in which the computing device is one of mobile phone, e-mail appliance, smart phone, non-smart phone, PDA, PC, notebook PC, laptop PC, ultra-mobile PC, tablet device, tablet PC, handheld game device, game console, digital media player, digital camera, GPS navigation device, Internet-connected television, set-top box, or device which combines one or more features thereof.

6. The method of claim 1 further including a step of receiving parameters from the hosted search app at the first API, the parameters including one of installed version, supported operating system, app icon path, app title, or localized caption to display in the UI.

7. The method of claim 1 further including a step of receiving parameters from the hosted search app at the second API, the parameters including one of app ID, installed version, supported operating system, app icon path, app title, extension category ID, or localized caption to display in the UI.

8. The method of claim 7 in which the second API is adapted to enable a side-loaded app to be injected into the hosted search app, and in which the parameters received at the second API further include a parameter to indicate that the side-loaded app is deployed on the computing device for testing purposes.

9. One or more computer-readable storage media, not consisting of a propagated signal, storing instructions which, when executed by one or more processors disposed in a computing device, perform a method for operating a local client computing device with communication to a remote server, the method comprising the steps of:
collecting a query including search terms from a user at the computing device using a hosted search application (app);
sending the search query to the remote server;
receiving an HTML payload from the remote server, the HTML payload including one or more HTML documents and data including one of app extension categories, app extension action, and a list of apps that are known to the remote server;
rendering the one or more HTML documents at the hosted search app to generate a user interface (UI) on the computing device;
comparing the list of known apps to apps that are installed on the client computing device to find one or more matching apps; and
if matching apps are found, displaying the one or matching apps through the UI.

10. The one or more computer-readable storage media of claim 9 in which the HTML payload is compliant with HTML5.

11. The one or more computer-readable storage media of claim 9 in which the method further includes the steps of receiving an input from the user through the UI to launch a selected app, and generating a launch command to launch the selected app responsively to the received input.

12. The one or more computer-readable storage media of claim 9 in which the method further includes the steps of calling a first application programming interface (API) exposed by the remote server, the first API being arranged to enable the hosted search app to update an install state of the installed apps on the client computing device.

13. The one or more computer-readable storage media of claim 9 in which the method further includes the steps of calling a second application programming interface (API) exposed by the remote server, the second API being arranged to enable the hosted search app to inject an app that is unknown to the remote server into the hosted search app.

14. The one or more computer-readable storage media of claim 13 in which the second API is adapted to enable a side-loaded app to be injected into the hosted search app via specification of a parameter that is indicative that the side-loaded app is interoperable with the hosted search app for development, testing, or debugging.

15. A system for testing side-loaded apps, the system comprising:
one or more computer-readable storage media storing computer code; and
a processor disposed on a local client computing device, the processor being responsive to the computer code, the computer program, when loaded into the processor, operable for
receiving HTML5 code from a remote server, the received code implementing a hosted search application (app) including a user interface (UI) on the local client computing device, the remote server exposing an API by which a side-loaded app may be injected into the hosted search app by specifying parameters, at least one of the specified parameters indicates that the side-loaded app is interoperable with the hosted search app for purposes of debugging,
receiving a query at the UI including one or more search terms from the user,
displaying the side-loaded app to the user if the side-loaded app is determined to have relevance to query,
launching the side-loaded app when selected by the user, the displaying and launching being performed for the debugging.

16. The system of claim 15 in which the API is a JavaScript API.

17. The system of claim 15 in which the specified parameters further include one of app ID, installed version, supported operating system, app icon path, app title, extension category ID, extension action ID, or localized caption to display in the UI.

18. The system of claim 15 in which determination of relevance is performed at the remote server.

19. The system of claim 18 in which the determination is performed by matching the search terms to an extension category, the side-loaded app being registered to the extension category.

20. The system of claim 18 in which the determination is performed by matching the search terms to an extension action, the side-loaded app being registered to the extension action.
